(19) United States
(12) Patent Application Publication
(10) Pub. No.: US 2021/0402809 A1
(43) Pub. Date: Dec. 30, 2021

(54) INKJET RECORDING DEVICE

(71) Applicant: KYOCERA Document Solutions Inc., Osaka-shi (JP)

(72) Inventor: Shigeharu ITO, Osaka-shi (JP)

(21) Appl. No.: 17/356,736

(22) Filed: Jun. 24, 2021

(30) Foreign Application Priority Data
Jun. 29, 2020 (JP) 2020-111186

(51) Int. Cl. B41J 11/42; B41J 2/165

(52) U.S. Cl. CPC B41J 11/42; B41J 2/16517

(57) ABSTRACT

An inkjet recording device includes: an endless conveyance belt having plural openings; a recording medium supply unit that supplies a recording medium to the conveyance belt; an opening position detection unit that detects positions of the openings in the conveyance belt; a flushing control unit that causes the recording head to perform flushing on the basis of position detection of the openings; and a recording medium supply control unit that controls the recording medium supply unit in any of plural control modes. The plural control modes include: a first control mode in which the recording medium supply unit is controlled independently from the position detection of the openings by the opening position detection unit; and a second control mode in which the recording medium supply unit is controlled on the basis of the position detection of the openings by the opening position detection unit.

### INCORPORATION BY REFERENCE

This application is based upon, and claims the benefit of priority from, corresponding Japanese Patent Application No. 2020-111186 filed in the Japan Patent Office on Jun. 29, 2020, the entire contents of which are incorporated herein by reference.

### BACKGROUND

### Field of the Invention

The present disclosure relates to an inkjet recording device.

### Description of Related Art

Typically, in an inkjet recording device such as an inkjet printer, flushing (empty ejection) is performed to periodically eject ink from a nozzle in order to reduce or prevent clogging of the nozzle caused by drying of the ink.

### SUMMARY

An inkjet recording device according to an aspect of the present disclosure includes: a recording head having plural nozzles, each of which ejects ink; an endless conveyance belt that conveys a recording medium to a position facing the recording head and has plural openings, through each of which the ink passes when the recording head performs flushing to eject the ink at different timing from timing that contributes to image formation on the recording medium; a recording medium supply unit that supplies the recording medium to the conveyance belt; an opening position detection unit that detects positions of the openings in the conveyance belt; a flushing control unit that causes the recording head to perform the flushing on the basis of position detection of the openings by the opening position detection unit; and a recording medium supply control unit that controls the recording medium supply unit in any of plural control modes. The plural control modes include: a first control mode in which the recording medium supply unit is controlled independently from the position detection of the openings by the opening position detection unit; and a second control mode in which the recording medium supply unit is controlled on the basis of the position detection of the openings by the opening position detection unit.

### BRIEF DESCRIPTION OF THE DRAWINGS

FIG. 1 is an explanatory view illustrating a schematic configuration of a printer as an inkjet recording device according to an embodiment of the present disclosure;

FIG. 2 is a plan view of a recording unit provided in the printer;

FIG. 3 is an explanatory view schematically illustrating a configuration around a paper conveyance path from a paper-feed cassette in the printer to a second conveying unit via a first conveying unit;

FIG. 4 is a block diagram illustrating a hardware configuration of main units of the printer;

FIG. 5 is a plan view illustrating a configuration example of a first conveyance belt provided in the first conveying unit;

FIG. 6 is an explanatory view schematically illustrating an exemplary pattern of an opening group for flushing and paper that is placed on the first conveyance belt according to the pattern at the time of using the first conveyance belt in FIG. 5;

FIG. 7 is an explanatory view schematically illustrating another example of the pattern and the paper that is placed on the first conveyance belt according to the pattern;

FIG. 8 is an explanatory view schematically illustrating further another example of the pattern and the paper that is placed on the first conveyance belt according to the pattern;

FIG. 9 is an explanatory view schematically illustrating yet another example of the pattern and the paper that is placed on the first conveyance belt according to the pattern;

FIG. 10 is a flowchart illustrating a processing flow by an example of control for a resist roller pair by a paper supply control unit;

FIG. 11 is an explanatory view schematically illustrating a placement position of each sheet of the paper that is supplied to the first conveyance belt by the control in FIG. 10;

FIG. 12 is a flowchart illustrating a modified example of the processing by the control;

FIG. 13 is a flowchart illustrating a processing flow by another example of the control;

FIG. 14 is an explanatory view schematically illustrating the placement position of each sheet of the paper that is supplied to the first conveyance belt by the control in FIG. 13;

FIG. 15 is a flowchart illustrating a processing flow by further another example of the control; and

FIG. 16 is an explanatory view schematically illustrating the placement positions of sheets of the paper in different sizes that are supplied to the first conveyance belt by the control in FIG. 15.

### DETAILED DESCRIPTION

1. Configuration of Inkjet Recording Device

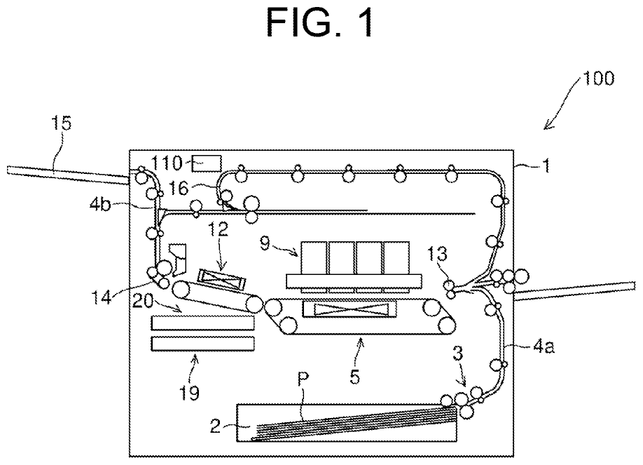

A description will hereinafter be made on an embodiment of the present disclosure with reference to the drawings. FIG. 1 is an explanatory view illustrating a schematic configuration of a printer 100 as an inkjet recording device according to the embodiment of the present disclosure. The printer 100 includes a paper-feed cassette 2 as a paper storage unit. The paper-feed cassette 2 is arranged in a lower portion of a printer body 1. Paper P as an example of a recording medium is stored in the paper-feed cassette 2.

A paper feeder 3 is arranged on a downstream side in a paper conveyance direction of the paper-feed cassette 2, that is, at a position on an upper right side of the paper-feed cassette 2 in FIG. 1. This paper feeder 3 separates the paper P per sheet and feeds the paper P upward to the right of the paper-feed cassette 2 in FIG. 1.

The printer 100 includes a first paper conveyance path 4a therein. The first paper conveyance path 4a is located on the upper right side of the paper-feed cassette 2 in a paper-feed direction thereof. The paper P, which is fed out of the paper-feed cassette 2, is conveyed perpendicularly upward on the first paper conveyance path 4a along a side surface of the printer body 1.

A resist roller pair 13 is provided at a downstream end of the first paper conveyance path 4a in the paper conveyance direction. Furthermore, a first conveying unit 5 and a recording unit 9 are arranged in the immediate vicinity on a downstream side in the paper conveyance direction of the resist roller pair 13. The paper P, which is fed out of the paper-feed cassette 2, reaches the resist roller pair 13 through the first paper conveyance path 4a. The resist roller pair 13 measures timing of ink ejection operation performed by the recording unit 9 and feeds the paper P toward the first conveying unit 5 (particularly, a first conveyance belt 8, which will be described below) while correcting diagonal feed of the paper P. That is, the resist roller pair 13 constitutes a recording medium supply unit that supplies the paper P onto the first conveyance belt 8.

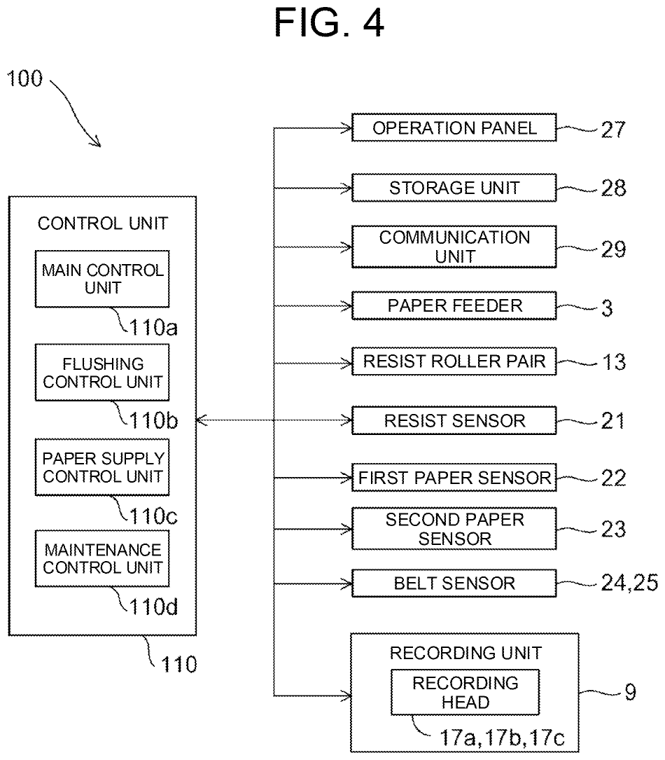

The paper P that is fed to the first conveying unit 5 by the resist roller pair 13 is conveyed by the first conveyance belt 8 to a position facing the recording unit 9 (particularly, recording heads 17a to 17c, which will be described below). Ink is ejected onto the paper P from the recording unit 9, and an image is thereby recorded on the paper P. At this time, the ink ejection in the recording unit 9 is controlled by a controller 110 (for example, a main control unit 110a, see FIG. 4) in the printer 100. The controller 110 is configured to include a central processing unit (CPU), for example, and has functions as a calculation unit that performs necessary calculations and a timekeeping unit that clocks time.

In the paper conveyance direction, a second conveying unit 12 is arranged on a downstream side (left side in FIG. 1) of the first conveying unit 5. The paper P, on which the image is recorded by the recording unit 9, is conveyed to the second conveying unit 12. The ink ejected onto a surface of the paper P is dried while passing through the second conveying unit 12.

In the paper conveyance direction, a decurler unit 14 is provided at a position on a downstream side of the second conveying unit 12 and near a left surface of the printer body 1. The paper P, on which the ink has been dried by the second conveying unit 12, is conveyed to the decurler unit 14, and the paper P is uncurled.

In the paper conveyance direction, a second paper conveyance path 4b is provided on a downstream side (upper side in FIG. 1) of the decurler unit 14. When double-sided recording is not performed, the paper P, which has passed through the decurler unit 14, passes through the second paper conveyance path 4b and is discharged to a paper exit tray 15 that is provided on the outside of a left surface of the printer 100.

A reversing conveyance path 16 for the double-sided recording is provided at a position in an upper portion of the printer body 1 and above the recording unit 9 and the second conveying unit 12. When the double-sided recording is performed, the paper P, recording on one surface (a first surface) of which is completed, and which has passed through the second conveying unit 12 and the decurler unit 14, is conveyed to the reversing conveyance path 16 through the second paper conveyance path 4b.

A conveyance direction of the paper P, which has been conveyed to the reversing conveyance path 16, is switched for subsequent recording on the other surface (a second surface) of the paper P. Then, the paper P passes through the upper portion of the printer body 1, is conveyed rightward, and is conveyed again to the first conveying unit 5 in a state where the second surface faces upward via the resist roller pair 13. In the first conveying unit 5, the paper P is conveyed to the position facing the recording unit 9, and an image is recorded on the second surface by the ink ejection from the recording unit 9. The paper P after the double-sided recording is discharged to the paper exit tray 15 via the second conveying unit 12, the decurler unit 14, and the second paper conveyance path 4b in this order.

A maintenance unit 19 and a cap unit 20 are arranged below the second conveying unit 12. The maintenance unit 19 moves horizontally at a position below the recording unit 9 when purging, wipes the ink pushed out of an ink ejection port of the recording head, and collects the wiped ink. Purging refers to operation to forcibly push out the ink from the ink ejection port of the recording head in order to discharge thickened ink, a foreign substance, or air bubbles in the ink ejection port. The cap unit 20 moves horizontally at the position below the recording unit 9 when capping an ink ejection surface of the recording head, further moves upward, and is mounted on a lower surface of the recording head.

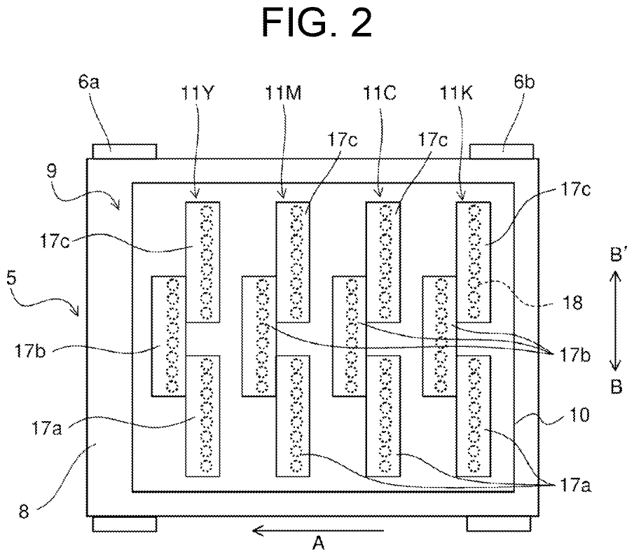

FIG. 2 is a plan view of the recording unit 9. The recording unit 9 includes a head housing 10 and line heads 11Y, 11M, 11C, 11K. The line heads 11Y to 11K are held by the head housing 10 in such a height that is provided with a specific clearance (for example, 1 mm) from a conveyance surface of the endless first conveyance belt 8 that is stretched around plural rollers including a drive roller 6a, a driven roller 6b, and tension rollers 7a, 7b. The drive roller 6a causes the first conveyance belt 8 to move in the conveyance direction of the paper P (an arrow A direction). Driving of this drive roller 6a is controlled by the controller 110 (for example, the main control unit 110a). The plural rollers are arranged in an order of the tension roller 7a, the tension roller 7b, the driven roller 6b, and the drive roller 6a along a moving direction of the first conveyance belt 8.

The line heads 11Y to 11K each have the plural (three herein) recording heads 17a to 17c. The recording heads 17a to 17c are arranged in a staggered manner along a paper width direction (an arrow BB′ direction) that is orthogonal to the paper conveyance direction (the arrow A direction). Each of the recording heads 17a to 17c has plural ink ejection ports 18 (nozzles). The ink ejection ports 18 are aligned at equally-spaced intervals in a width direction of the recording head, that is, the paper width direction (the arrow BB′ direction). The ink in each color of yellow (Y), magenta (M), cyan (C), and black (K) is ejected onto the paper P, which is conveyed on the first conveyance belt 8, from respective one of the line heads 11Y to 11K via the ink ejection ports 18 of the recording heads 17a to 17c.

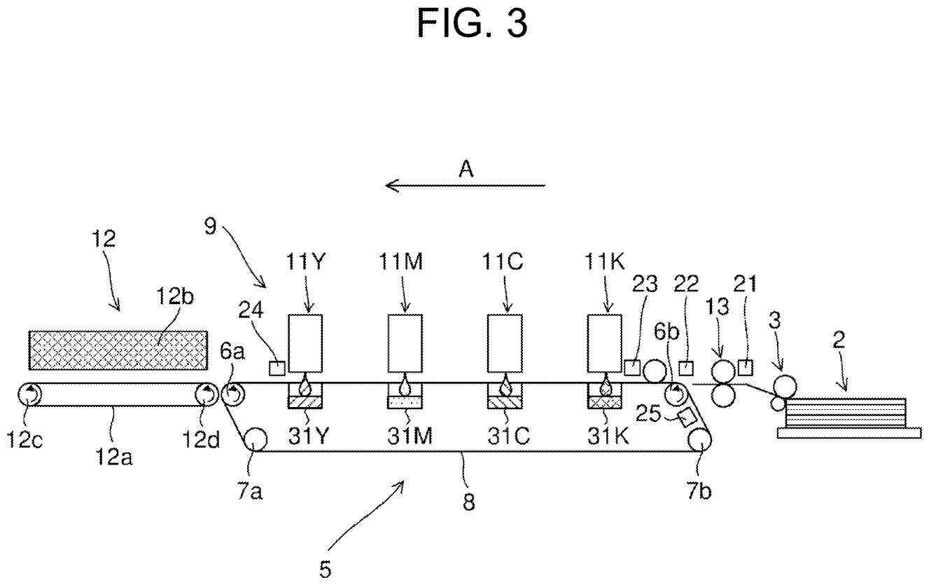

FIG. 3 schematically illustrates a configuration around the conveyance path of the paper P from the paper-feed cassette 2 to the second conveying unit 12 via the first conveying unit 5. FIG. 4 is a block diagram illustrating a hardware configuration of main units of the printer 100. In addition to the above components, the printer 100 further includes a resist sensor 21, a first paper sensor 22, a second paper sensor 23, and belt sensors 24, 25.

The resist sensor 21 detects the paper P that is conveyed from the paper-feed cassette 2 by the paper feeder 3 and is fed to the resist roller pair 13. This resist sensor 21 is located on an upstream side of the resist roller pair 13 in a supply direction of the paper P. The controller 110 (for example, a paper supply control unit 110c) can control rotation start timing of the resist roller pair 13 on the basis of a detection result by the resist sensor 21. For example, based on the detection result by the resist sensor 21, the controller 110 can control supply timing of the paper P, which has been subjected to skew (incline) correction by the resist roller pair 13, to the first conveyance belt 8.

The first paper sensor 22 detects a position in the width direction of the paper P that is conveyed from the resist roller pair 13 to the first conveyance belt 8. Based on a detection result by the first paper sensor 22, the controller 110 (for example, the main control unit 110a) can cause the ink ejection ports 18, which correspond to the width of the paper P, among the ink ejection ports 18 in the recording heads 17a to 17c of the line head 11Y to 11K to eject the ink so as to record the image on the paper P.

The second paper sensor 23 detects passing of the paper P that is supplied to the first conveyance belt 8 by the resist roller pair 13. That is, the second paper sensor 23 detects the position in the conveyance direction of the paper P that is conveyed by the first conveyance belt 8. The second paper sensor 23 is located at a position that is on an upstream side of the recording unit 9 and on a downstream side of the first paper sensor 22 in the paper conveyance direction. Based on a detection result by the second paper sensor 23, the controller 110 (for example, the main control unit 110a) can control the ink ejection timing onto the paper P that reaches a position facing the line heads 11Y to 11K (the recording heads 17a to 17c) by the first conveyance belt 8.

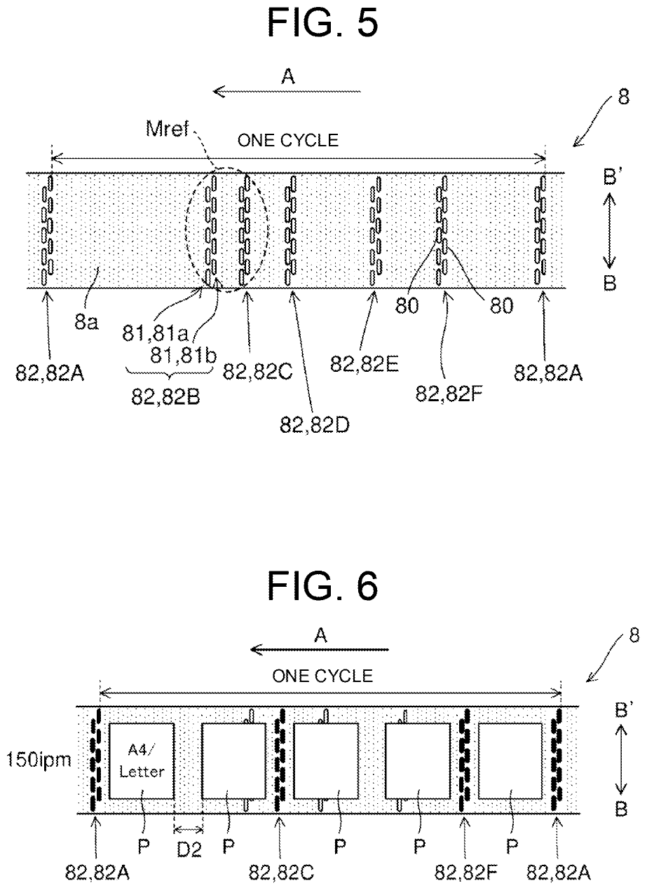

Each of the belt sensors 24, 25 is a reference detection sensor that detects a reference specifying portion Mref (see FIG. 5) provided to the first conveyance belt 8. The reference specifying portion Mref is a portion indicative of a reference for one round of the first conveyance belt 8, and is configured to include a combination of two adjacent opening groups 82 as will be described below. As will be described below, a positional relationship between the reference specifying portion Mref and another opening 80 (opening group 82) is known in advance. Thus, by detecting the reference specifying portion Mref of the first conveyance belt 8, the belt sensors 24, 25 can each detect a position of each of the openings 80 (the opening groups 82), which are provided to the first conveyance belt 8, in the conveyance direction. For this reason, it can be said that each of the belt sensors 24, 25 functions as an opening position detection unit that detects the position of each of the openings 80 of the first conveyance belt 8.

Here, in an end portion of the first conveyance belt 8 in a belt width direction, a mark may be formed at a position corresponding to each of the opening groups 82. Then, when detecting the mark, each of the belt sensors 24, 25 may detect the position of the opening group 82 (the openings 80) corresponding to such a mark.

The belt sensor 24 is located on a downstream side of the recording unit 9 in the paper conveyance direction (the moving direction of the first conveyance belt 8). The belt sensor 25 is located on an upstream side in the paper conveyance direction of the driven roller 6b, on which the first conveyance belt 8 is stretched. In this embodiment, the belt sensor 25 is located between the driven roller 6b and the tension roller 7b, but may be located between the tension roller 7a and the tension roller 7b. The driven roller 6b is located on the upstream side of the recording unit 9 in the moving direction of the first conveyance belt 8. The belt sensor 24 has an equivalent function to the second paper sensor 23. Based on the detection result by the belt sensor 24 or 25, the controller 110 (for example, the paper supply control unit 110c) can control the resist roller pair 13 in a manner to supply the paper P to the first conveyance belt 8 at specific timing.

Furthermore, the position of the paper P is detected by the plural sensors (the second paper sensor 23 and the belt sensor 24), and the reference specifying portion Mref of the first conveyance belt 8 is detected by the plural sensors (the belt sensors 24, 25). In this way, it is also possible to correct an error in the detected position and to detect abnormality.

Each of the first paper sensor 22, the second paper sensor 23, and the belt sensors 24, 25 described above may be constructed of a transmissive or reflective optical sensor, a contact image sensor (CIS), or the like.

In addition, the printer 100 may be configured to include a meandering detection sensor that detects meandering of the first conveyance belt 8 and to correct the meandering of the first conveyance belt 8 on the basis of the detection result thereby.

The printer 100 further includes an operation panel 27, a storage unit 28, and a communication unit 29.

The operation panel 27 is an operation unit for accepting input of various settings by a user. For example, the user can operate the operation panel 27 to input information on size of the paper P to be set in the paper-feed cassette 2, that is, the information on the size of the paper P to be conveyed by the first conveyance belt 8. The user can also command initiation of a print job or specify the number of sheets of the paper P to be printed by operating the operation panel 27.

The storage unit 28 is memory that stores an operation program for the controller 110 and stores various types of information, and is configured to include read only memory (ROM), random access memory (RAM), non-volatile memory, or the like. The storage unit 28 stores the information that is set by using the operation panel 27 (for example, the information on the size and the number of sheets of the paper P).

The communication unit 29 is a communication interface used to exchange the information with an external device (for example, a personal computer (PC)). For example, when the user operates the PC and sends a print command and image data to the printer 100, the image data and the print command are input to the printer 100 via the communication unit 29. In the printer 100, the controller 110 (for example, the main control unit 110a) controls the recording heads 17a to 17c and causes the recording heads 17a to 17c to eject the ink on the basis of the image data, and the image can thereby be recorded on the paper P.

As illustrated in FIG. 3, the printer 100 has ink receiving units 31Y, 31M, 31C, 31K on an inner circumferential surface side of the first conveyance belt 8. When the recording heads 17a to 17c perform flushing, the ink receiving units 31Y to 31K respectively receive and collect the ink that is ejected from the recording heads 17a to 17c and passes through the openings 80 of the first conveyance belt 8. For this reason, the ink receiving units 31Y to 31K are provided at positions facing the recording heads 17a to 17c of the line heads 11Y to 11K via the first conveyance belt 8, respectively. The ink that is collected by the ink receiving units 31Y to 31K is sent to a waste ink tank and is discarded, for example, but may be reused instead of being discarded.

Here, the flushing refers to the ejection of the ink from the ink ejection ports 18 at different timing from timing, which contributes to the image formation (image recording) on the paper P, for a purpose of reducing or preventing clogging of the ink ejection ports 18 caused by drying of the ink. The controller 110 (for example, a flushing control unit 110b) controls the flushing by the recording heads 17a to 17c.

The above-described second conveying unit 12 is configured to include a second conveyance belt 12a and a drier 12b. The second conveyance belt 12a is stretched by two of a drive roller 12c and a driven roller 12d. The paper P, which has been conveyed by the first conveying unit 5, and on which the image has been recorded by the ink ejection by the recording unit 9, is conveyed by the second conveyance belt 12a, is dried by the drier 12b during the conveyance, and is then conveyed to the above-described decurler unit 14.

As illustrated in FIG. 4, the printer 100 has the controller 110. The controller 110 has the main control unit 110a, the flushing control unit 110b, the paper supply control unit 110c, and a maintenance control unit 110d. The control units constituting the controller 110 are constructed of the single CPU. However, it is needless to say that such control units may be constructed of different CPUs.

The main control unit 110a controls operation of each of the components of the printer 100. For example, the main control unit 110a controls driving of each of the rollers in the printer 100, the ink ejection from the recording heads 17a to 17c during the image formation (other than during the flushing), and the like.

The flushing control unit 110b causes the recording heads 17a to 17c to perform the flushing on the basis of the position detection of the openings 80 by the belt sensor 24 or 25. A detailed description will be made below on the flushing that is based on the position detection of the openings 80.

The paper supply control unit 110c is a recording medium supply control unit that controls the resist roller pair 13 as the recording medium supply unit in any of plural control modes. For example, the paper supply control unit 110c controls the resist roller pair 13 in any of the plural control modes according to the total number of sheets of the paper P to be printed. Alternatively, the paper supply control unit 110c controls the resist roller pair 13 in any of the plural control modes according to the number of sheets of the paper P that is supplied to the first conveyance belt 8 from a reference time point. Here, the reference time point can be assumed to be, for example, a time point at which an image formation start instruction is accepted by receiving a control signal from the external PC or by the operation of the operation panel 27 of the printer 100.

The plural control modes of the resist roller pair 13 by the paper supply control unit 110c include a first control mode and a second control mode. The first control mode is a control mode in which the resist roller pair 13 is controlled independently from the position detection of the openings 80 by the belt sensor 24 or 25 (irrespective of the position detection). The second control mode is a control mode in which the resist roller pair 13 is controlled on the basis of the position detection of the openings 80 by the belt sensor 24 or 25. A specific example of control for the resist roller pair 13 by the paper supply control unit 110c will be described below.

The maintenance control unit 110d executes control for causing the recording heads 17a to 17c to perform above-described purging that forcibly pushes the ink out of each of the ink ejection ports 18. The maintenance control unit 110d also controls driving of the above-described maintenance unit 19 (for example, downward movement and evacuation of the recording unit 9) when causing the recording heads 17a to 17c to perform purging.

2. Details of First Conveyance Belt

2-1. One Configuration Example of First Conveyance Belt

Next, a description will be made on details of the first conveyance belt 8 in the first conveying unit 5. FIG. 5 is a plan view illustrating a configuration example of the first conveyance belt 8. In this embodiment, a negative-pressure suction method is adopted to suction and convey the paper P onto the first conveyance belt 8 by negative-pressure suction. For this reason, the first conveyance belt 8 is provided with innumerable suction holes 8a, through each of which suction air generated by the negative-pressure suction passes.

The first conveyance belt 8 is also provided with the opening groups 82. Each of the opening groups 82 is a set of the openings 80, through each of which the ink ejected from each of the nozzles (the ink ejection ports 18) of the recording heads 17a to 17c passes during the flushing. An opening area of the single opening 80 is larger than an opening area of the single suction hole 8a. The first conveyance belt 8 has the plural opening groups 82 in the conveyance direction (an A direction) of the paper P in one cycle, and has the six opening groups 82 in this embodiment. Here, one cycle means a period in which the first conveyance belt 8 makes one round. When the opening groups 82 are distinguished from each other, the six opening groups 82 will be referred to as opening groups 82A to 82F from a downstream side in the A direction. The above suction holes 8a are located between the opening group 82 and the opening group 82 that are adjacent to each other in the A direction. That is, in the first conveyance belt 8, the suction holes 8a are not formed in a region that overlaps the opening group 82 (around the openings 80).

In the one cycle of the first conveyance belt 8, the opening groups 82 are irregularly located in the A direction. That is, in the A direction, a distance between the opening group 82 and the opening group 82 that are adjacent to each other is not constant but varies. At this time, the maximum distance between the two adjacent opening groups 82 in the A direction (for example, a distance between the opening group 82A and the opening group 82B in FIG. 5) is longer than a length of the paper P in the A direction at the time when the paper P in the minimum printable size (for example, A4 size (horizontally placed)) is placed on the first conveyance belt 8.

The opening group 82 has an opening row 81. The opening row 81 is configured by aligning the plural openings 80 in the belt width direction (the paper width direction, the BB′ direction) that is orthogonal to the A direction. Each of the opening groups 82 has at least one opening row 81 in the A direction and, in this embodiment, has two opening rows 81. When the two opening rows 81 are distinguished from each other, one thereof will be referred to as an opening row 81a, and the other will be referred to as an opening row 81b.

In the single opening group 82, the openings 80 in any of the opening rows 81 (for example, the opening row 81a) are located in a manner to shifted in the BB′ direction from the openings 80 in the other opening row 81 (for example, the opening row 81b) and are located in a manner to partially overlap the openings 80 in the other opening row 81 (for example, the opening row 81b) when seen in the A direction. In addition, in each of the opening rows 81, the plural openings 80 are located at equally-spaced intervals in the BB′ direction.

Since the plural opening rows 81 are aligned in the A direction to form the single opening group 82 as described above, a width of the opening group 82 in the BB′ direction is greater than a width of the recording heads 17a to 17c in the BB′ direction. Accordingly, the opening group 82 covers an entire ink ejection region in the BB′ direction of the recording heads 17a to 17c, and the ink that is ejected from all the ink ejection ports 18 of the recording heads 17a to 17c during the flushing passes through any of the openings 80 in the opening group 82.

From what have been described so far, it can be said that the first conveyance belt 8 has the opening groups 82 at the plural positions at the different intervals in the A direction as the conveyance direction, and each of the opening groups 82 includes the openings 80, through which the ink ejected from the recording heads 17a to 17c during the flushing passes.

2-2. Regarding Patterns of Opening Groups Used for Flushing

In this embodiment, while the paper P is conveyed by using the first conveyance belt 8, the controller 110 (for example, the main control unit 110a) controls the recording heads 17a to 17c on the basis of the image data sent from the external device (for example, the PC). In this way, the image is recorded on the paper P. At the time, the controller 110 (for example, the flushing control unit 110b) causes the recording heads 17a to 17c to perform the flushing between the paper P and the paper P that are conveyed (the flushing between sheets of the paper), so as to reduce or prevent clogging of the ink ejection ports 18.

Here, in this embodiment, according to the size of the paper P to be used, the controller 110 (for example, the flushing control unit 110b) determines a pattern (a combination) in the A direction of the plural opening groups 82 that are used during the flushing in the one cycle of the first conveyance belt 8. The controller 110 can recognize the size of the paper P to be used on the basis of the information stored in the storage unit 28 (for example, size information of the paper P that is input through the operation panel 27). Note that the pattern of the opening groups 82 is literally distinguished from a placement pattern of the paper P, which will be described below.

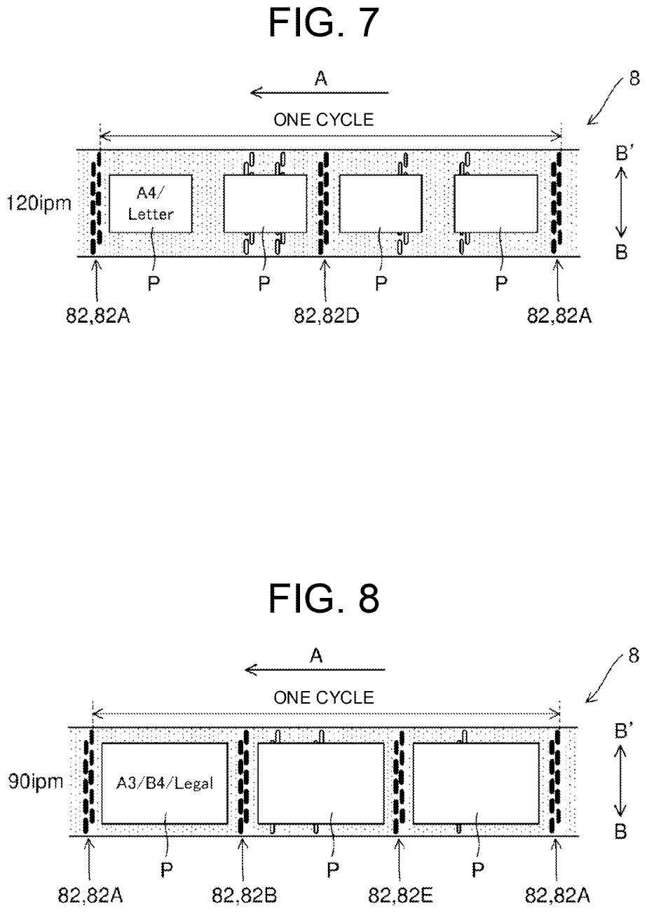

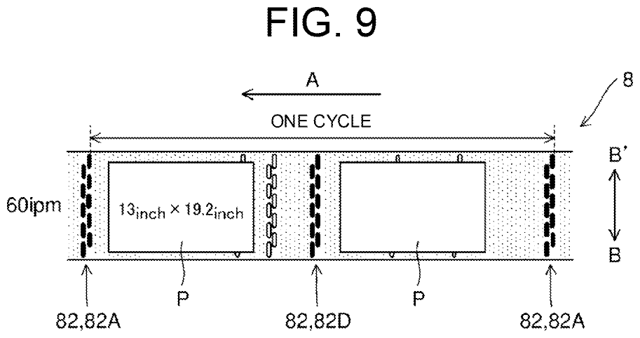

FIG. 6 to FIG. 9 each illustrate an example of the pattern of the opening groups 82 per paper P in the different size. For example, in the case where the paper P to be used is in the A4 size (horizontally placed) or letter size (horizontally placed), the controller 110 selects the pattern of the opening groups 82 illustrated in FIG. 6. That is, of the six opening groups 82 illustrated in FIG. 5, the controller 110 selects, as the opening groups 82 used for the flushing, the opening groups 82A, 82C, 82F. In the case where the paper P to be used is in the A4 size (longitudinally placed) or the letter size (longitudinally placed), as illustrated in FIG. 7, of the six opening groups 82, the controller 110 selects, as the opening groups 82 used for the flushing, the opening groups 82A, 82D. In the case where the paper P to be used is in A3 size, B4 size, or legal size (longitudinally placed in any of the cases), as illustrated in FIG. 8, of the six opening groups 82, the controller 110 selects, as the opening groups 82 used for the flushing, the opening groups 82A, 82B, 82E. In the case where the paper P to be used is in size of 13 inches×19.2 inches, as illustrated in FIG. 9, of the six opening groups 82, the controller 110 selects, as the opening group 82 used for flushing, the opening groups 82A, 82D. In each of the drawings, the openings 80 in the opening groups 82 that belong to the above pattern are illustrated in black for convenience.

Then, the controller 110 causes the recording heads 17a to 17c to perform the flushing at such timing that the opening groups 82 located in the determined pattern face the recording heads 17a to 17c by the movement of the first conveyance belt 8. Here, a moving speed (a paper conveyance speed) of the first conveyance belt 8, the distance between two each of the opening groups 82A to 82E, and a positional relationship between the first conveyance belt 8 and each of the recording heads 17a to 17c and the belt sensor 24, 25 are all known. Accordingly, for example, when the opening group 82B and the opening group 82C with the shortest distance therebetween in the A direction in the first conveyance belt 8 are considered as the reference specifying portion Mref indicative of the reference for the one round of the belt, and when the belt sensor 24 or 25 detects passing of the reference specifying portion Mref by the movement of the first conveyance belt 8, it can be understood when each of the opening groups 82A to 82E passes the position facing the recording heads 17a to 17c several seconds after a time point of such detection. Thus, based on the detection result by the belt sensor 24 or 25, the controller 110 can cause the recording heads 17a to 17c to perform the flushing at such timing that the opening groups 82 located in the above-determined pattern face the recording heads 17a to 17c.

2-3. Regarding Paper Placement Pattern

In this embodiment, as described above, the controller 110 (for example, the paper supply control unit 110c) controls the resist roller pair 13 in the first control mode or the second control mode so as to control the supply timing of the paper P to the first conveyance belt 8 by the resist roller pair 13. When the resist roller pair 13 is controlled in the first control mode, the paper P can be supplied to the first conveyance belt 8 and placed on the first conveyance belt 8 irrespective of the positions of the openings 80 with respect to the first conveyance belt 8.

Meanwhile, when the resist roller pair 13 is controlled in the second control mode, based on the position detection of the openings 80 by the belt sensor 24 or 25, the paper supply control unit 110c causes the resist roller pair 13 to supply the paper P at the position between the plural opening groups 82, which are aligned in the A direction in the above-determined pattern, on the first conveyance belt 8.

For example, in the case where the paper P to be used is in the A4 size (horizontally placed) or in the letter size (horizontally placed), as illustrated in FIG. 6, the controller 110 controls the resist roller pair 13 to supply the paper P to the first conveyance belt 8 at specific supply timing such that, on the first conveyance belt 8, two sheets of the paper P are arranged between the opening group 82A and the opening group 82C, two sheets of the paper P are arranged between the opening group 82C and the opening group 82F, and one sheet of the paper P is arranged between the opening group 82F and the opening group 82A in the next cycle. At this time, the controller 110 controls the resist roller pair 13 to supply the paper P to the first conveyance belt 8 such that, on the first conveyance belt 8, each sheet of the paper P is arranged at the position away from respective one of the opening groups 82A, 82C, 82F, which are located in the above pattern, by a specific distance or longer in the A direction (including both directions on the upstream side and the downstream side). Here, the specific distance is set to 10 mm as an example.

Here, the controller 110 (for example, the paper supply control unit 110c) can determine the supply timing of the paper P by the resist roller pair 13 on the basis of the detection result by the belt sensor 24 or 25. For example, when the belt sensor 25 detects passing of the reference specifying portion Mref by the movement of the first conveyance belt 8, the controller 110 can determine timing which is several seconds after a time point of such detection and at which the paper P is supplied to the first conveyance belt 8 by the resist roller pair 13, so as to be able to arrange the paper P at each of the positions illustrated in FIG. 6. Thus, the controller 110 determines the supply timing of the paper P on the basis of the detection result by the belt sensor 25, and controls the resist roller pair 13 such that the paper P is supplied at the determined supply timing. In this way, the paper P can be arranged at the positions illustrated in FIG. 6 on the first conveyance belt 8 substantially at equally-spaced intervals. In the example illustrated in FIG. 6, five sheets of the paper P can be conveyed in one cycle of the first conveyance belt 8, and 150 images per minute (ipm) can be achieved as number of printed sheets of the paper P per minute (productivity).

In the case where the paper P to be used is in the A4 size (longitudinally placed) or in the letter size (longitudinally placed), as illustrated in FIG. 7, the controller 110 controls the resist roller pair 13 to supply the paper P to the first conveyance belt 8 at the specific supply timing such that, on the first conveyance belt 8, two sheets of the paper P are arranged between the opening group 82A and the opening group 82D and two sheets of the paper P are arranged between the opening group 82D and the opening group 82A in the next cycle. In the example illustrated in FIG. 7, four sheets of the paper P can be conveyed in the one cycle of the first conveyance belt 8, and the productivity of 120 ipm can be achieved.

In the case where the paper P to be used is in A3 size, B4 size, or the legal size (longitudinally placed in any case), as illustrated in FIG. 8, the controller 110 controls the resist roller pair 13 to supply the paper P to the first conveyance belt 8 at the specific supply timing such that, on the first conveyance belt 8, one sheet of the paper P is arranged between the opening group 82A and the opening group 82B, one sheet of the paper P is arranged between the opening group 82B and the opening group 82E, and one sheet of the paper P is arranged between the opening group 82E and the opening group 82A in the next cycle. In the example illustrated in FIG. 8, three sheets of the paper P can be conveyed in the one cycle of the first conveyance belt 8, and the productivity of 90 ipm can be achieved.

In the case where the paper P to be used is in the size of 13 inches×19.2 inches, as illustrated in FIG. 9, the controller 110 controls the resist roller pair 13 to supply the paper P to the first conveyance belt 8 at the specific supply timing such that, on the first conveyance belt 8, one sheet of the paper P is arranged between the opening group 82A and the opening group 82D and one sheet is the paper P is arranged between the opening group 82D and the opening group 82A in the next cycle. In the example illustrated in FIG. 9, two sheets of the paper P can be conveyed in the one cycle of the first conveyance belt 8, and the productivity of 60 ipm can be achieved.

That is, as illustrated in FIG. 6 to FIG. 9, the pattern of the opening groups 82 used for flushing is determined according to the size of the paper P to be used, and the placement pattern of the paper P that is shifted from the opening groups 82 in the A direction is determined. From the above, it can be said that the placement pattern of the paper P, which is placed on the first conveyance belt 8, is determined according to the size of the paper to be used.

The controller 110 (for example, the main control unit 110a) causes the recording heads 17a to 17c to eject the ink at such timing that each sheet of the paper P faces the recording heads 17a to 17c by the movement of the first conveyance belt 8, so as to be able to form the image on each sheet of the paper P. The timing at which each sheet of the paper P faces the recording heads 17a to 17c is determined on the basis of the detection result of the paper P by the second paper sensor 23 (see FIG. 4).

3. Paper Supply Control to First Conveyance Belt

Next, a description will be made on the specific example of the control for the resist roller pair 13 by the paper supply control unit 110c in the controller 110.

3-1. Case where Total Number of Sheets of Paper to be Printed is Set in Advance

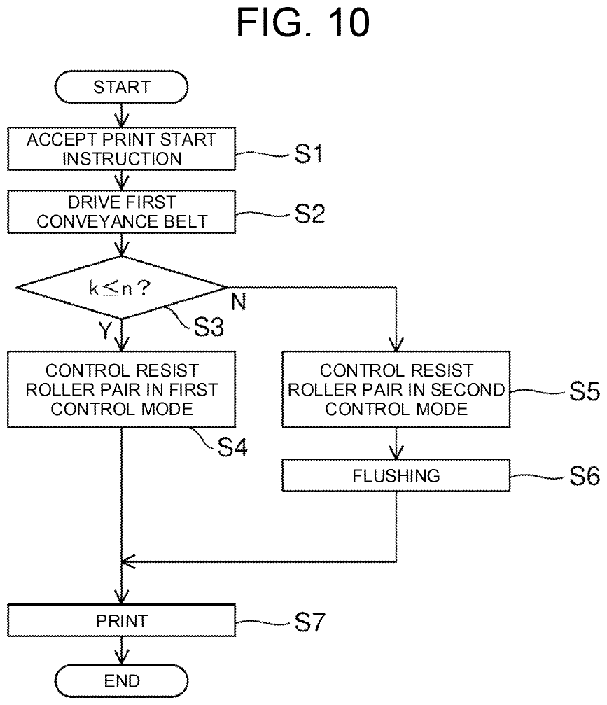

FIG. 10 is a flowchart illustrating a processing flow by the example of the control for the resist roller pair 13 by the paper supply control unit 110c. Here, it is assumed that total number of sheets k of the paper P to be printed is set in advance. Note that k is an integer that is equal to or larger than 1 and equal to or smaller than N, and N is an integer that is equal to or larger than 2. It is also assumed that all the sheets of the paper P to be printed are in the same size (for example, the A4 size (horizontally placed)).

The paper supply control unit 110c can determine whether the total number of sheets k is set on the basis of the information on the number of sheets, which is included in the control signal (a print instruction signal) sent from the external PC to the printer 100 or on the basis of the information on the number of sheets, which is input in advance through the operation panel 27 and stored in the storage unit 28.

In the printer 100, when a print (image formation) start instruction on the paper P is accepted by receiving the control signal from the external PC by the communication unit 29 or by the operation of the operation panel 27 (S1), the main control unit 110a in the controller 110 drives the drive roller 6a to start driving (moving) the first conveyance belt 8 (S2).

Next, the paper supply control unit 110c determines whether the total number of sheets k, which is set, is smaller than specific number of sheets n (S3). The specific number of sheets n is set in advance through the operation panel 27 or the like. The specific number of sheets n is number of sheets that is allowed when the image is formed on the paper P without the flushing by the recording heads 17a to 17c. In other words, the specific number of sheets n is number of sheets with which image quality of the printed image is acceptable when the image is formed on the paper P without the flushing by the recording heads 17a to 17c. For example, in the case where the paper P to be used is in the A4 size (horizontally placed), n=2 is set.

If the total number of sheets k is equal to or smaller than the specific number of sheets n (Yes in S3), the paper supply control unit 110c controls the resist roller pair 13 in the first control mode (S4). That is, the paper supply control unit 110c controls the resist roller pair 13 to supply the number of sheets k of the paper P to the first conveyance belt 8 at close intervals irrespective of the position detection of the openings 80 by the belt sensor 24 or 25.

After S4, the flushing control unit 110b in the controller 110 does not cause the recording heads 17a to 17c to perform the flushing, and the processing proceeds to S7 as is. In S7, the main control unit 110a in the controller 110 controls the recording heads 17a to 17c to eject the ink. In this way, the images are formed on the number of sheets k of the paper P that is sequentially supplied onto the first conveyance belt 8.

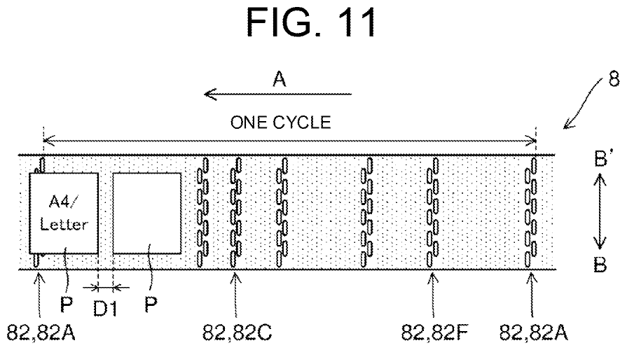

For example, FIG. 11 schematically illustrates the placement position of each sheet of the paper P supplied to the first conveyance belt 8 in the case where N=n=2. In FIG. 11, on the first conveyance belt 8, there are the paper P (see a first sheet) that is placed in an overlapping manner with the openings 80 (the opening group 82) and the paper P (see a second sheet) that is shifted from the openings 80 in the conveyance direction (the A direction). However, as described above, the flushing is not performed after S4. Thus, even when there is the paper P that is placed in the overlapping manner with the openings 80 in S4, this does not pose any particular problem (since the flushing itself is not performed, there is no need to place the paper P to be shifted from the openings 80 in consideration of the flushing).

On the other hand, if the total number of sheets k is equal to or larger than three, that is, if the total number of sheets k exceeds the specific number of sheets n (No in S3), the paper supply control unit 110c controls the resist roller pair 13 in the second control mode (S5). That is, as illustrated in FIG. 6, based on the position detection of the openings 80 by the belt sensor 24 or 25, the paper supply control unit 110c sequentially supplies the number of sheets k of the paper P to the first conveyance belt 8 by the resist roller pair 13 such that the number of sheets k of the paper P is located in the particular placement pattern (located to be shifted from the particular openings 80 for flushing (the openings 80 in the opening groups 82A, 82C, 82F) in the A direction) on the first conveyance belt 8.

Then, the flushing control unit 110b causes the recording heads 17a to 17c to perform the flushing at such timing that the openings 80 for flushing face the recording heads 17a to 17c (S6). Meanwhile, the main control unit 110a causes the recording heads 17a to 17c to eject the ink at such timing that each sheet of the paper P faces the recording heads 17a to 17c, so as to form the image on each sheet of the paper P (S7). Then, a series of the print processing is terminated.

As it has been described so far, the control modes of the resist roller pair 13 by the paper supply control unit 110c include the first control mode and the second control mode. Thus, the paper supply control unit 110c can control the resist roller pair 13 by selecting the first control mode or the second control mode according to the total number of sheets k of the paper P as described above. In this way, it is possible to selectively exert an effect by the first control mode (an effect of terminating printing early) or an effect by the second control mode (an effect of suppressing degradation of the image quality by the flushing) according to the total number of sheets k of the paper P. A further detailed description will be made below on each of the effect by the first control mode and the effect by the second control mode.

In the case where the resist roller pair 13 is controlled in the first control mode, the paper P can be supplied immediately from the resist roller pair 13 to the first conveyance belt 8 irrespective of the positions of the openings 80. That is, there is no need to adjust (delay) supply of the paper P by the resist roller pair 13 according to the positions of the openings 80. In this way, it is possible to promptly supply the paper P to the first conveyance belt 8 by the resist roller pair 13 and to cause the paper P to promptly reach the position facing the recording heads 17a to 17c. As a result, by the ink ejection from the recording heads 17a to 17c (S7), printing on the number of sheets k of the paper P can be completed as quickly as possible. In particular, printing on the first sheet of paper P (a first print time) can be completed quickly.

Meanwhile, in the case where the resist roller pair 13 is controlled in the second control mode, for example, the paper P can be supplied from the resist roller pair 13 to the first conveyance belt 8 such that the paper P is placed at the position that is shifted in the conveyance direction (to the upstream side) from the particular openings 80 in the first conveyance belt 8. In this case, the flushing control unit 110b causes the recording heads 17a to 17c to perform the flushing at such timing that the recording heads 17a to 17c face the openings 80 (S6), so as to be able to reduce clogging caused by drying of the ink in each of the ink ejection ports 18. Accordingly, during subsequent printing on the paper P, the ink can be ejected favorably from each of the ink ejection ports 18 in the recording heads 17a to 17c, and printing can be performed favorably (S7). As a result, it is possible to suppress the degradation of the image quality of the image that is formed on the paper P.

In particular, the paper supply control unit 110c selects the first control mode or the second control mode according to the total number of sheets k of the paper P to be printed (to be formed with the image), and controls the resist roller pair 13 in the selected control mode. In this way, it is possible to reliably exert the effect that differs by the total number k of sheets of the paper P to be printed (the effect of terminating printing early or the effect of suppressing the degradation of the image quality by the flushing).

In the case where k is the integer that is equal to or larger than 1 and equal to or smaller than N, where N is the integer that is equal to or larger than 2, and where the total number of sheets k of the paper P to be printed is equal to or smaller than the number of sheets n, which is set in advance, the paper supply control unit 110c controls the resist roller pair 13 in the first control mode to supply the number of sheets k of the paper P to the first conveyance belt 8 (S4). Meanwhile, in the case where the total number of sheets k of the paper P to be printed exceeds the number of sheets n, the paper supply control unit 110c controls the resist roller pair 13 in the second control mode to supply the number of sheets k of the paper P to the first conveyance belt 8 (S5). Since the paper supply control unit 110c selects the first control mode or the second control mode on the basis of a comparison between the total number of sheets k of the paper P and the number of sheets n, which is set in advance, the control mode can be selected easily, and the resist roller pair 13 can easily be controlled in the selected control mode.

By the way, the distance between the sheets of the paper P, which are continuously supplied from the resist roller pair 13 to the first conveyance belt 8 when the resist roller pair 13 is controlled in the first control mode, is set as D1 (mm) (see FIG. 11). Meanwhile, the distance between the sheets of the paper P, which are continuously supplied from the resist roller pair 13 to the first conveyance belt 8 when the resist roller pair 13 is controlled in the second control mode, is set as D2 (mm) (see FIG. 6). At this time, the distance D1 is shorter than the distance D2. That is, in the first control mode, the plural sheets of the paper P are supplied to the first conveyance belt 8 at the closer interval than that in the second control mode. Thus, it is reliably possible to promptly complete printing on all the sheets of the paper P, which are supplied to the first conveyance belt 8, by the control in the first control mode.

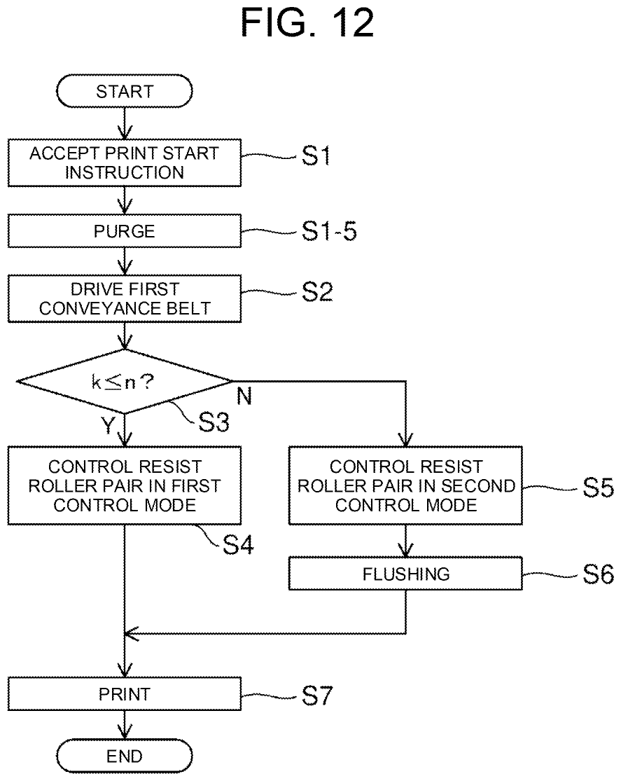

FIG. 12 is a flowchart illustrating a modified example of the processing by the above-described control. After the print start instruction on the paper P is accepted in S1, in S2, the maintenance control unit 110d in the controller 110 may cause the recording heads 17a to 17c to perform purging prior to driving of the first conveyance belt 8 by the drive roller 6a (S1 to 5). At this time, the maintenance unit 19 (see FIG. 1) moves to the position below the recording heads 17a to 17c, wipes the ink pushed out of each of the ink ejection ports 18 by purging, and collects the wiped ink.

Just as described, the maintenance control unit 110d causes the recording heads 17a to 17c to perform purging in advance. In this way, even in the case where the processing is thereafter executed in an order of S3 to S4 and S7, that is, even in the case where the image is printed on the paper P without flushing, the favorable image can be formed on the paper P by ejecting the favorable ink after purging (the ink that is not thickened) from each of the ink ejection ports 18 in the recording heads 17a to 17c.

3-2. Case where Total Number of Sheets of Paper to be Printed is Undetermined

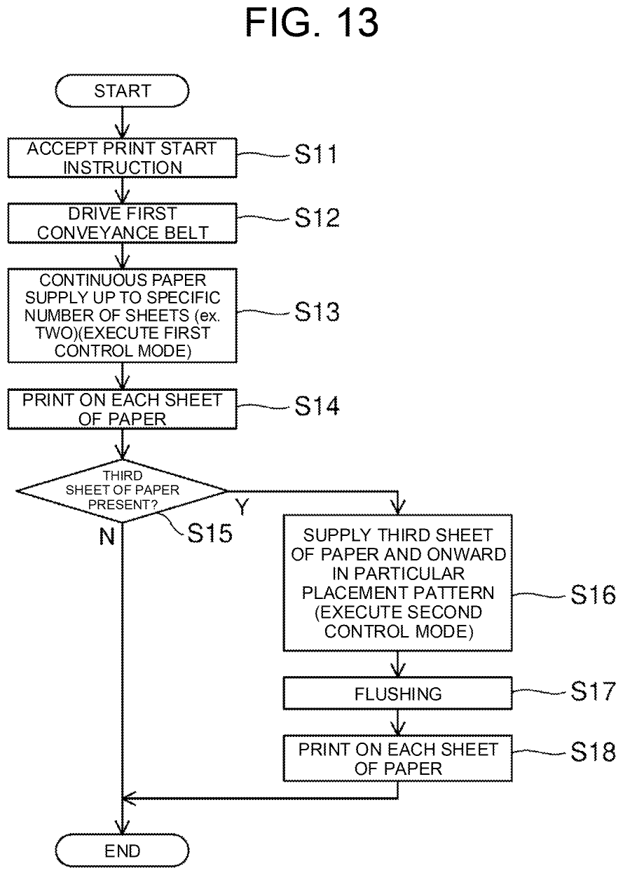

FIG. 13 is a flowchart illustrating a processing flow by another example of the control for the resist roller pair 13 by the paper supply control unit 110c.

A description will herein be made on a case where the total number of sheets of paper P to be printed is undetermined. For example, in the case where the image data to be printed on the paper P is sent from the external PC to the printer 100 one after another per printing on the paper P, the printer 100 cannot recognize the total number of sheets of the paper P. Also, in the case where the print jobs are input one after another through the operation panel 27, the printer 100 cannot recognize the total number of sheets of the paper P to be printed. In such cases, the following processing can be executed. It is assumed herein that all the sheets of the paper P to be printed are in the same size (for example, the A4 size (horizontally placed)).

In the printer 100, when the print start instruction on the paper P is accepted by receiving the control signal from the external PC by the communication unit 29 or by the operation of the operation panel 27 (S11), the main control unit 110a in the controller 110 drives the drive roller 6a to start driving the first conveyance belt 8 (S12). A time point at which the print start instruction is accepted in S11 is set as a reference time point.

Next, the paper supply control unit 110c controls the resist roller pair 13 in the first control mode until the number of sheets of the paper P supplied to the first conveyance belt 8 reaches the specific number of sheets n, which is set in advance (an upper limit of the number of supplied sheets includes n) (S13). That is, the paper supply control unit 110c controls the resist roller pair 13 such that the paper P is sequentially supplied to the first conveyance belt 8 independently from (irrespective of) the position detection of the openings 80 by the belt sensor 24 or 25. Note that n is an integer that is equal to or larger than 1, and n=2 is set, for example.

After S13, the flushing control unit 110b does not cause the recording heads 17a to 17c to perform the flushing, and the processing proceeds to S14 as is. In S14, the main control unit 110a controls the recording heads 17a to 17c to eject the ink. In this way, the image is formed on each sheet of the paper P that is sequentially supplied onto the first conveyance belt 8.

Next, based on the control signal from the external PC or the information input through the operation panel 27, the paper supply control unit 110c determines whether third and subsequent sheets of the paper P exist as print targets (S15). If the third and subsequent sheets of the paper P do not exist (No in S15), the number of sheets of the paper P as the print targets is originally small (for example, the number of sheets of the paper P as the print targets is originally two), printing on those sheets of the paper P is completed, and a series of the processing is terminated. The placement position of each sheet of the paper P on the first conveyance belt 8 at the time when printing on the paper P is completed in two sheets is the same as that in FIG. 11.

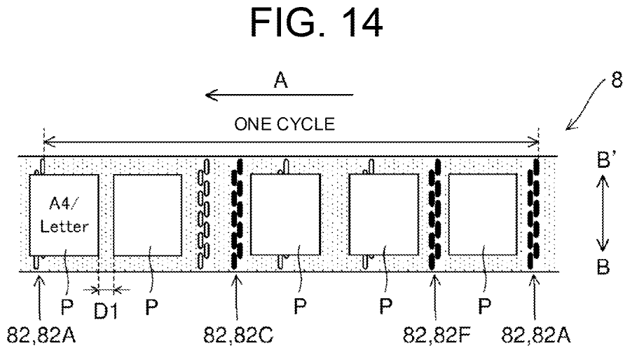

On the other hand, if the paper supply control unit 110c determines that the third and subsequent sheets of the paper P exist as the print targets, that is, if the paper supply control unit 110c determines that the number of sheets of the paper P supplied to the first conveyance belt 8 exceeds the specific number of sheets n (Yes in S15), the paper supply control unit 110c controls the resist roller pair 13 in the second control mode to supply the third and subsequent sheets of the paper P to the first conveyance belt 8 (S16). That is, based on the position detection of the openings 80 by the belt sensor 24 or 25, the paper supply control unit 110c sequentially supplies the third and subsequent sheets of the paper P to the first conveyance belt 8 by the resist roller pair 13 such that the third and subsequent sheets of the paper P are located in the particular placement pattern (located to be shifted from the particular openings 80 for flushing (the openings 80 in the opening groups 82C, 82F, 82A) in the A direction) on the first conveyance belt 8. When the number of sheets of the paper P as the print targets is five, the placement position of each sheet of the paper P supplied to the first conveyance belt 8 is as illustrated in FIG. 14.

Then, the flushing control unit 110b causes the recording heads 17a to 17c to perform the flushing at such timing that the openings 80 for flushing face the recording heads 17a to 17c (S17). In an example illustrated in FIG. 14, the flushing control unit 110b causes the recording heads 17a to 17c to perform the flushing at such timing that the particular openings 80 (the openings 80 in the opening groups 82C, 82F, 82A) face the recording heads 17a to 17c (the openings 80 as flushing targets are illustrated in black in FIG. 14). Meanwhile, the main control unit 110a causes the recording heads 17a to 17c to eject the ink at such timing that each sheet of the paper P faces the recording heads 17a to 17c, so as to form the image on each sheet of the paper P (S18). Then, a series of the print processing is terminated.

As it has been described so far, the paper supply control unit 110c selects the first control mode or the second control mode according to the number of sheets of the paper P that is supplied to the first conveyance belt 8 from the reference time point in S1, and controls the resist roller pair 13 in the selected control mode (513 to S16). In this way, even in the case where the total number of sheets of the paper P to be printed is undetermined, it is possible to selectively exert the effect by the first control mode (the effect of terminating printing early) or the effect by the second control mode (the effect of suppressing the degradation of the image quality by the flushing) according to the number of supplied sheets (an elapsed time) from the reference time point.

In particular, in the case where n is set as the integer that is equal to or larger than 1, the paper supply control unit 110c controls the resist roller pair 13 in the first control mode before the number of sheets of the paper P supplied to the first conveyance belt 8 reaches the number of sheets n, which is set in advance. Then, after the number of sheets of the paper P supplied to the first conveyance belt 8 reaches the number of sheets n, the paper supply control unit 110c controls the resist roller pair 13 in the second control mode (513 to S16). In this case, it is possible to reliably exert the effect by the first control mode or the effect by the second control mode according to the number of supplied sheets (the elapsed time) from the reference time point.

The above-described reference time point is the time point at which the print (image formation) start instruction is accepted by receiving the control signal from the external device or by the operation of the operation panel 27 provided to the device (the printer 100) (S11). In this case, the resist roller pair 13 is controlled in the first control mode or the second control mode according to the elapsed time from the time point at which the print start instruction is accepted, and the above-described effect by the first control mode or the second control mode can thereby selectively be exerted.

The point that the maintenance control unit 110d in the controller 110 may cause the recording heads 17a to 17c to perform purging prior to driving of the first conveyance belt 8 by the drive roller 6a is the same as that in the above-described modified example in 3-1.

3-3. Case where Size of Paper is Changed in the Middle of Printing

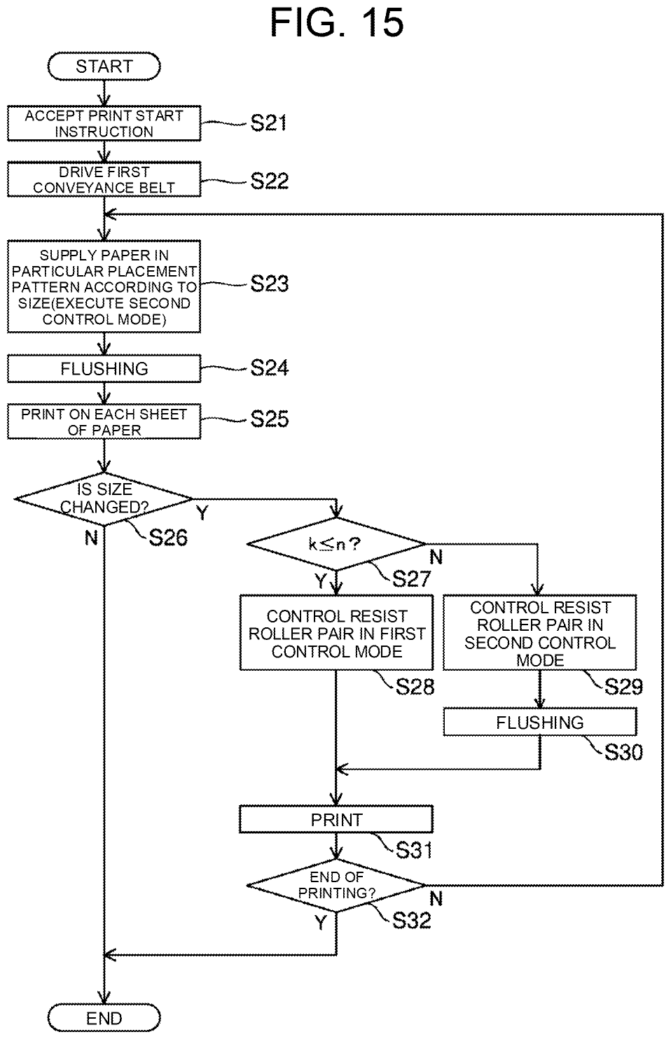

FIG. 15 is a flowchart illustrating a processing flow by further another example of the control for the resist roller pair 13 by the paper supply control unit 110c. A description will herein be made on a case where, as an example, only one sheet of paper P′ in the A4 size (longitudinally placed) is printed in the middle of printing on the plural sheets of the paper P in A4 size (horizontally placed).

The A4 size (horizontal placement) is set as a first size, the A4 size (longitudinally placed) is set as a second size, and these sizes are distinguished from each other. In addition, it is assumed that the paper feeder 3 in the printer 100 stores the paper P, P′ in different sizes in separate paper-feed trays and is controlled by the controller 110 (for example, the main control unit 110a) so as to appropriately feed the paper P or P′ to the resist roller pair 13.

In the printer 100, when the print start instruction on the paper P is accepted by receiving the control signal from the external PC by the communication unit 29 or by the operation of the operation panel 27 (S21), the main control unit 110a in the controller 110 drives the drive roller 6a to start driving the first conveyance belt 8 (S22).

The paper supply control unit 110c controls the resist roller pair 13 in the second control mode to supply the plural sheets of the paper P in the A4 size (horizontally placed) to the first conveyance belt 8 (S23). As a result, the plural sheets of the paper P are placed on the first conveyance belt 8 in the particular placement pattern illustrated in FIG. 6.

Then, the flushing control unit 110b causes the recording heads 17a to 17c to perform the flushing at such timing that the particular openings 80 for flushing (the openings 80 in the opening groups 82A, 82C, 82F) face the recording heads 17a to 17c (S24). Meanwhile, the main control unit 110a causes the recording heads 17a to 17c to eject the ink at such timing that each sheet of the paper P faces the recording heads 17a to 17c, so as to form the image on each sheet of the paper P (S25).

Next, the paper supply control unit 110c determines whether the size of the paper P is changed (S26). The paper supply control unit 110c can determine whether the size of the paper P is changed on the basis of the control signal, which has been received from the external PC in S21, or the information input by the operation of the operation panel 27. If the size of paper P is not changed (No in S26), printing on the plural sheets of the paper P in the A4 size (horizontally placed) as the first size is completed, and a series of the processing is terminated.

On the other hand, if the size of the paper P is changed (Yes in S26), the paper supply control unit 110c determines whether the total number of sheets k of the paper P′ after the size change (here, the paper in the A4 size (longitudinally placed) as the second size) is equal to or smaller than less than the specific number of sheets n (S27). Note that n is the integer that is equal to or larger than 1 and equal to or smaller than N, and N is the integer that is equal to or larger than 2. Here, n=1 is set.

If the total number of sheets k of the paper P′ is equal to or smaller than the specific number of sheets n, that is, if the number of sheets of the paper P′ in the second size is one (Yes in S27), the paper supply control unit 110c controls the resist roller pair 13 in the first control mode (S28). More specifically, the paper supply control unit 110c controls the resist roller pair 13 to supply one sheet of the paper P′ to the first conveyance belt 8 irrespective of the position detection of the openings 80 by the belt sensor 24 or 25.

After S28, the flushing control unit 110b does not cause the recording heads 17a to 17c to perform the flushing, and the processing proceeds to S31 as is. In S31, the main control unit 110a controls the recording heads 17a to 17c to eject the ink onto the paper P′ in the second size. In this way, the image is formed on the paper P′ that is supplied onto the first conveyance belt 8.

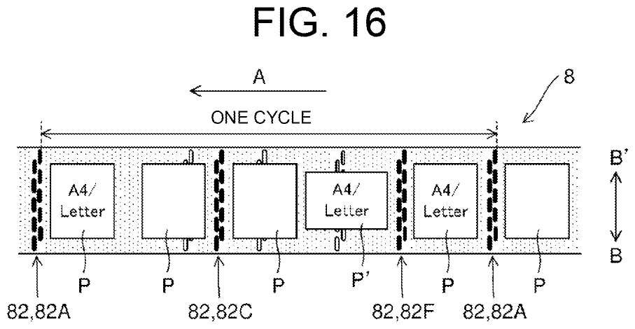

For example, FIG. 16 schematically illustrates the placement positions of the paper P in the first size and the paper P′ in the second size that are supplied to the first conveyance belt 8. As illustrated in FIG. 16, it is understood that the paper P in the first size is placed on the first conveyance belt 8 in the manner to be shifted from the particular openings 80 for flushing (the openings 80 in the opening groups 82A, 82C) in the conveyance direction. On the contrary, it is understood that the paper P′ in the second size is supplied onto the first conveyance belt 8 in a manner to be placed on the downstream side of the above openings 80 without waiting for passing of the next openings 80 for flushing (the opening 80 in the opening group 82A in a second cycle) corresponding to the second size. In S31, the ink is ejected and the image is formed on the paper P′ that is placed on the first conveyance belt 8 just as described.

If the total number of sheets k of the paper P′ exceeds the specific number of sheets n, that is, if the number of sheets of the paper P′ in the second size is two or larger (No in S27), the paper supply control unit 110c controls the resist roller pair 13 in the second control mode (S29). More specifically, based on the position detection of the openings 80 by the belt sensor 24 or 25, the paper supply control unit 110c sequentially supplies the number of sheets k of the paper P′ to the first conveyance belt 8 by the resist roller pair 13 such that the number of sheets k of the paper P′ is located in the particular placement pattern (located to be shifted from the particular openings 80 for flushing (the openings 80 in the opening groups 82D, 82A) in the A direction) on the first conveyance belt 8 (see FIG. 7).

Then, the flushing control unit 110b causes the recording heads 17a to 17c to perform the flushing at such timing that the openings 80 for flushing face the recording heads 17a to 17c (S30). Meanwhile, the main control unit 110a causes the recording heads 17a to 17c to eject the ink at such timing that each sheet of the paper P′ faces the recording heads 17a to 17c, so as to form the image on each sheet of the paper P′ (S31).

After S31, if there is no further paper to be printed (for example, the paper P in the first size), printing of all the paper is completed (Yes in S32), and a series of the processing is terminated. On the other hand, if there is the paper to be printed (for example, the paper P in the first size), printing of all the paper is not completed (No in S32). Then, the processing returns to S23, and the processing in S23 onward is repeated. The paper supply control unit 110c can determine whether there is further paper to be printed on the basis of the control signal, which has been received from the external PC in S21, or the information input by the operation of the operation panel 27.

As it has been described so far, when the paper size is changed from the first size to the second size (S26), the paper supply control unit 110c selects the first control mode or the second control mode according to the total number of sheets of the paper P′ in the second size, and controls the resist roller pair 13 in the selected control mode (S27 to S28). In this way, even in the case where the paper size is changed in the middle of printing, it is possible to selectively exert the effect by the first control mode (the effect of terminating printing early) or the effect by the second control mode (the effect of suppressing the degradation of the image quality by the flushing) for the paper P′ in the changed size.

In particular, in the case where k is set as the integer that is equal to or larger than 1 and equal to or smaller than N and N is set as the integer that is equal to or larger than 2, the paper supply control unit 110c controls the resist roller pair 13 in the first control mode to supply the number of sheets k of the paper P′ to the first conveyance belt 8 at the time when the total number of sheets k of the paper P′ in the second size is equal to or smaller than the number of sheets n, which is set in advance, or the paper supply control unit 110c controls the resist roller pair 13 in the second control mode to supply the number of sheets k of the paper P′ to the first conveyance belt 8 at the time when the total number of sheets k exceeds the number of sheets n (S28, S29). In this case, the supply control of the paper P′ in the changed size to the first conveyance belt 8 is executed in the first control mode or the second control mode. In this way, it is possible to reliably exert the effect by the first control mode or the effect by the second control mode.

The point that the maintenance control unit 110d in the controller 110 may cause the recording heads 17a to 17c to perform purging prior to driving of the first conveyance belt 8 by the drive roller 6a is the same as the above-described modified example in 3-1.

4. Others

The description has been made so far on the case where the paper P is suctioned onto and conveyed on the first conveyance belt 8 by the negative-pressure suction. However, the first conveyance belt 8 may electrically be charged, and the paper P may electrostatically be suctioned onto and conveyed on the first conveyance belt 8 (an electrostatic suction method). Also, in this case, it is possible to adopt such a configuration that the first conveyance belt 8 is provided with plural marks 90.

The description has been made so far on the example in which, as the inkjet recording device, the color printer is used to record the colored image by using the four colors of the ink. However, the configuration and the control in this embodiment can also be applied to a case where a monochrome printer is used to record a monochrome image by using the black ink.

The present disclosure can be used for the inkjet recording device such as an inkjet printer.

What is claimed is:

1. An inkjet recording device comprising:
a recording head having plural nozzles, each of which ejects ink;
an endless conveyance belt that conveys a recording medium to a position facing the recording head and has plural openings, through each of which the ink passes when the recording head performs flushing to eject the ink at different timing from timing that contributes to image formation on the recording medium;
a recording medium supply unit that supplies the recording medium to the conveyance belt;
an opening position detection unit that detects positions of the openings in the conveyance belt;
a flushing control unit that causes the recording head to perform the flushing on the basis of position detection of the openings by the opening position detection unit; and
a recording medium supply control unit that controls the recording medium supply unit in any of plural control modes, wherein the plural control modes include:
a first control mode in which the recording medium supply unit is controlled independently from the position detection of the openings by the opening position detection unit; and
a second control mode in which the recording medium supply unit is controlled on the basis of the position detection of the openings by the opening position detection unit.

2. The inkjet recording device according to claim 1, wherein
in the second control mode, the recording medium supply control unit controls the recording medium supply unit to supply the recording medium to the conveyance belt such that, on the conveyance belt, the recording medium is placed at a position that is shifted in a conveyance direction from the particular opening detected by the opening position detection unit, and
a distance between the recording mediums, which are continuously supplied from the recording medium supply unit to the conveyance belt in the first control mode, is shorter than a distance between the recording mediums, which are continuously supplied from the recording medium supply unit to the conveyance belt in the second control mode.

3. The inkjet recording device according to claim 1, wherein
the recording medium supply unit selects the first control mode or the second control mode according to total number of sheets of the recording mediums, on each of which the image is formed, and controls the recording medium supply unit in the selected control mode.

4. The inkjet recording device according to claim 3, wherein
in the case where k is set as an integer that is equal to or larger than 1 and equal to or smaller than N, and N is set as an integer that is equal to or larger than 2,
the recording medium supply control unit controls the recording medium supply unit in the first control mode to supply the number of sheets k of the recording mediums to the conveyance belt at the time when the total number of sheets k of the recording mediums is equal to or smaller than number of sheets n, which is set in advance, or controls the recording medium supply unit in the second control mode to supply the number of sheets k of the recording mediums to the conveyance belt at the time when the total number of sheets k of the recording mediums exceeds the number of sheets n.

5. The inkjet recording device according to claim 1, wherein
the recording medium supply control unit selects the first control mode or the second control mode according to number of sheets of the recording mediums supplied to the conveyance belt from a reference time point, and controls the recording medium supply unit in the selected control mode.

6. The inkjet recording device according to claim 5, wherein
the recording medium supply unit controls the recording medium supply unit in the first control mode before the number of sheets of the recording mediums supplied from the reference time point reaches the number of sheets n, which is set in advance, and controls the recording medium supply unit in the second control mode after the number of sheets of the recording mediums reaches the number of sheets n.

7. The inkjet recording device according to claim 5, wherein
the reference time point is a time point at which an instruction to start the image formation is accepted by receiving a control signal from an external device or by an operation on an operation unit provided to the device.

8. The inkjet recording device according to claim 1, wherein
when a size of the recording medium is changed from a first size to a second size, the recording medium supply control unit selects the first control mode or the second control mode according to total number of sheets of the recording mediums in the second size and controls the recording medium supply unit in the selected control mode.

9. The inkjet recording device according to claim 8, wherein
in the case where k is set as an integer that is equal to or larger than 1 and equal to or smaller than N, and N is set as an integer that is equal to or larger than 2,
the recording medium supply control unit controls the recording medium supply unit in the first control mode to supply the number of sheets k of the recording mediums to the conveyance belt at the time when the total number of sheets k of the recording mediums in the second size is equal to or smaller than number of sheets n, which is set in advance, or controls the recording medium supply unit in the second control mode to supply the number of sheets k of the recording mediums to the conveyance belt at the time when the total number of sheets k of the recording mediums exceeds the number of sheets n.

10. The inkjet recording device according to claim 1 further comprising:
a drive roller that drives the conveyance belt; and
a maintenance control unit that causes the recording head to perform purging that forcibly pushes the ink out of each of the nozzles prior to driving of the conveyance belt by the drive roller.
